(19) United States
(12) Patent Application Publication
(10) Pub. No.: US 2005/0220250 A1
(43) Pub. Date: Oct. 6, 2005

(54) Pad-around-nozzle welding technique

(76) Inventors: Ron J. Payne, Forest, VA (US); Rob C. Smith, Goode, VA (US); John A. Orr, Lynchburg, VA (US); Gary R. Poling, Lynchburg, VA (US)

Correspondence Address: VYTAS R. MATAS, 2412 CEDARWOOD RD., PEPPER PIKE, OH, 44124, US

(21) Appl. No.: 11/032,905

(22) Filed: Jan. 11, 2005

Related U.S. Application Data
(60) Provisional application No. 60/536,147, filed on Jan. 13, 2004.

(51) Int. Cl. G21C 13/00

(52) U.S. Cl. 376/204

(57) ABSTRACT

The present invention changes the known use of a weld pad and allows the weld pad to be deposited while the existing nozzle is not defective and remains in place so when the nozzle becomes defective a new pressure boundary weld is used only when required resulting in minimized utility downtime.

### BACKGROUND OF THE INVENTION

1. Field of the Invention

The present invention is generally drawn to welding techniques used in pressure vessel replacement or repair and more particularly to such welding techniques using a weld pad on the outside of the pressure vessel in the nozzle area for nozzle repair.

2. Description of the Prior Art

A typical nuclear power generating facility includes in part a reactor vessel, steam generator, pressurizer vessel, and a reactor coolant piping system, all of which operate under high pressure. Nozzles are attached to the vessels and/or piping for a number of purposes such as for connecting piping and instrumentation, vents, and to secure control element drive mechanisms and heater elements. A typical pressurizer vessel (10) is shown in FIG. 1 with nozzles (12) for vents, nozzles (14) for sample liquid level or pressure sensing a nozzle (16) for temperature measuring, and a number of nozzles (20) for heating elements. All of these nozzles are welded to the pressurizer vessel at the time of original manufacture.

As shown in FIG. 2, Inconel or stainless cladding (22) is welded to the interior of the pressurizer vessel which is made of carbon steel. The nozzle (16) shown in cross section in FIG. 2, is examplary of the mentioned welded nozzles which all pass through a hole or bore (24) in the pressurizer vessel (10) and which are structurally welded at the interior end (26) to the vessel (10) with a J-groove weld (28) along the interior opening to the bore (24). The diameter of nozzle (16) is slightly less than the diameter of bore (24), so that there is a small annular space (30) between the nozzle exterior and the wall of bore (24). In some applications the nozzles are fit tight to the bore, and in a control rod drive mechanism, they are installed with a shrink fit process. The J-groove weld (28) also functions as a seal weld to seal the annular space (30). A reactor vessel (not shown) similarly has nozzles represented by nozzle (16) in FIG. 2 welded thereto. Then corresponding reactor vessel nozzles are located in the lower spherical head and allow instrumentation to be inserted into the reactor core. The piping of the reactor coolant system (not shown) also includes similar nozzles welded thereto. Further details of pressurizer vessels, reactor vessels, and coolant system piping, in particular, and nuclear power facilities, in general, are known to those of skill in the art.

Nozzle failures and leakage in nuclear power facilities is mainly due to SCC (stress corrosion cracking) phenomenon, which occurs on components having a susceptible material, high tensile stresses, high temperature and which are in a corrosive environment, conditions which primarily exist on nozzle penetration in the pressurizer vessel, reactor coolant piping, and the reactor vessel. Such failures are manifested by cracking. Such cracking occurs at the grain boundaries on the inside diameter of the nozzle material (alloy 600) at or near the heat affected zone of the weld and propagates radially outward through the thickness of the nozzle which eventually leads to small leakage of the reactor coolant supply. Failures have also occurred on stainless steel pressurizer nozzles.

As indicated, nozzles of these types have failed over time and have had to be replaced or repaired, either because of a failure in the nozzle or the weld attaching and sealing the nozzle to the vessel. A typical replacement procedure in a nuclear power plant environment requires shutting down the nuclear power plant and removing the nozzle in part or entirely. This typically requires machining operations to remove the nozzle and welding a replacement nozzle to the vessel or piping. The welded replacement nozzles closely duplicate the original welded nozzle they replace, except that they may be made of a different alloy, e.g., Alloy 690 which is less susceptible to SCC instead of Alloy 600.

In order to accomplish the new structural weld on replacement nozzles without the use of high preheat temperatures and to avoid the necessity for a bi-metallic weld, a weld pad is first deposited on the OD of the pressure vessel around a nozzle penetration. A J-groove weld prep is machined or ground into the weld pad into which the new pressure boundary structural weld is formed between the replacement nozzle and the weld pad. The current state-of-the-art repair equipment requires complete or partial removal of the existing nozzle in order to deposit the weld pad. The weld pad is deposited about an axis that is normal to the penetration tangent plane. An ambient temperature temper bead (ATTB) weld pad is deposited on the OD of the pressure vessel around the nozzle penetration using the machine Gas Tungsten Arc Welding (GTAW) process. No preheating or post weld heat treating (PWHT) is required. A J-groove weld prep is machined or ground into the weld pad into which the new pressure boundary structure weld is deposited between the replacement nozzle and the weld pad (similar metal welding).

The ASME Code requires the ATTB weld pad process to include a 48-hour hold at the completion of the weld to allow for the manifestation of potential hydrogen diffusion cracking phenomenon. This adds significant impact to the duration of outage schedules especially if multiple repairs are required. A new repair approach was needed to minimize this impact.

### BRIEF SUMMARY OF THE INVENTION

The present invention changes the known use of a weld pad and allows the weld pad to be deposited while the existing nozzle is not defective and remains in place. When the nozzle becomes defective a new pressure boundary weld is used only when one is required. Thus utilities can apply the weld pad during normal outages such as refueling well in advance of a nozzle repair without breaching the primary system pressure boundary.

This deposition of the weld pads can be scheduled into plant outages as part of routine maintenance. When the plant has required nozzle repair the weld pad is already in place and the plant is faced with simpler, shorter nozzle repair duration. The impact on the outage schedule is thus minimized.

Early weld pad deposition also requires less weld metal by virtue of its tool path which is about the vertical axis of the nozzle and the weld pad is deposited without breaching the pressure boundary. This approach called the Pad-Around-the nozzle (PAN) repair provides an alternative that would reduce this impact. Significant is that here is a clearance annular gap between the weld pad and the nozzle. This methodology promotes less weld residual stress and eliminates the axial thermal stresses imposed since the nozzle is now free ended and allowed to grow thermally when the vessel heats up.

In view of the foregoing it will be seen that one aspect of the present invention is to minimize plant outage due to nozzle repair.

Another aspect is to minimize the use of weld metal for a weld pad nozzle repair.

These and other aspects will be more fully understood after a review of the following description of the preferred embodiment in conjunction with the accompanying drawings.

### BRIEF DESCRIPTION OF THE DRAWINGS

In the drawings wherein:

FIG. 1 is a cross sectional view of a known pressurizer vessel shown for illustrative purposes as the invention is applicable to small diameter nozzles located in other primary system components and piping as well;

FIG. 2 is a cross sectional view of a nozzle taken along section 2-2 of FIG. 1;

FIG. 3 is a depiction of an existing nozzle having a weld pad welded thereto;

FIG. 4 is a depiction of a half-nozzle repair done to the nozzle of FIG. 3; and

FIG. 5 is a depiction of a full nozzle repair done to the nozzle of FIG. 3.

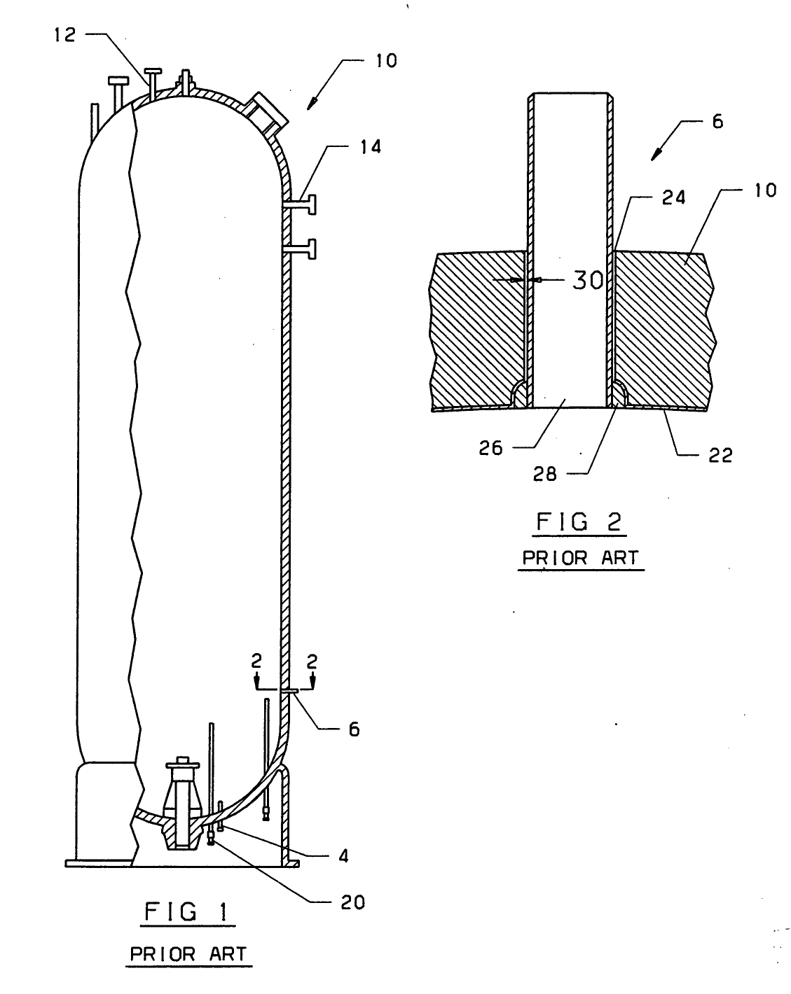

### DESCRIPTION OF THE PREFERRED EMBODIMENT

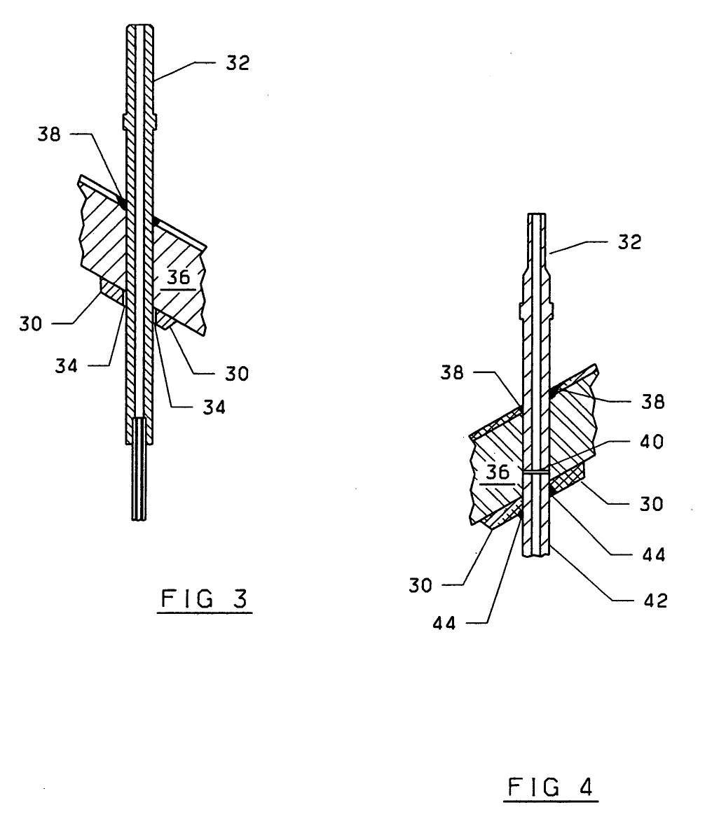

Referring now to the drawings generally and particularly to FIG. 3 the installation of a typical weld pad (30) around a pressure vessel nozzle (32) is shown during a normal plant outage representing the installation of weld pads around an existing nozzle which is requiring no repair at that time. The nozzle (32) is of course solidly retained to the pressure vessel (36) by a weld (38) inside the vessel (36). The weld pad is deposited leaving a clearance annular gap (34) between the weld pad and the nozzle. This is to preclude operational stresses from being imparted to the nozzle (30) due to restraint. It also eliminates the effects of weld residual stresses including weld shrinkage and the potential for bending of the nozzle (32) if weld pads are deposited in parallel with other operations during scheduled outages. The weld pad (30) will thus already be in place in the event that an unplanned nozzle (32) modification is required. This will reduce the scheduling impact of the unplanned modification on the duration of the outage.

Now when any of the PAD weld pad prepared nozzles become defective, either a partial or full nozzle replacement may be in order and the following nozzle replacement steps are performed.

For a partial replacement shown in FIG. 4, the nozzle (32) is cut off just below the weld (38) along line (40) and the existing lower part (42) of the nozzle (32) is removed. A new replacement nozzle is inserted in its place and it is manually welded to the pad (30) by a known J-groove weld (44) after machining a J-groove weld prep into the weld pad (30). The J-groove is typically formed by rotating a burr grinder against a cam to achieve the desired weld prep profile. The repaired nozzle is then rewelded to the system piping (not shown) as required.

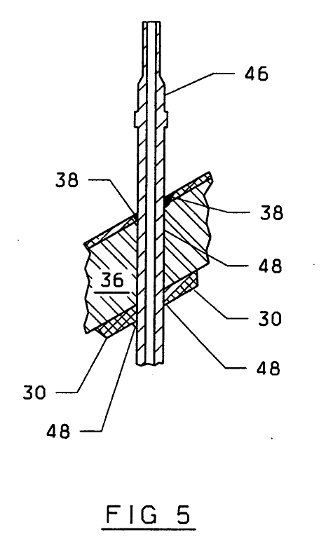

Referring now to FIG. 5 it will be seen that in this embodiment the entire nozzle (32) has been machined out and a new replacement nozzle (46) has been inserted in place thereof. The new nozzle has been welded to the pad (30) by a manual fillet structural pressure boundary weld (48) thus eliminating a need for machining of the J-groove weld prep.

The fillet structure pressure boundary weld requires the same analytical justification as the J-groove/fillet weld, but may require subjective securitization against the rigid requirements of the ASME code.

Certain details and obvious modification have been deleted herein for the sake of conciseness and readability but are properly intended to fall within the scope of the following claims. As an example, it will be understood that either a manual J-groove weld or a manual fillet structural weld could be used for both the partial and full nozzle replacements.

1. A method of repairing pressure vessel nozzles comprising the steps of:
a) depositing a weld pad around an existing nozzle that is not defective during normal power plant outage; and
b) repairing the existing nozzle when it becomes defective at a later date.

2. A method as set forth in claim 1 wherein the step of depositing a weld pad is done so as to leave a clearance annular gap between the weld pad and the nozzle.

3. A method as set forth in claim 2 wherein the step of repairing the existing nozzle includes a partial replacement of the nozzle and a welding of the replacement nozzle to the weld pad.

4. A method as set forth in claim 3 wherein the welding of the replacement nozzle is done with a J-weld.

5. A method as set forth in claim 3 wherein the welding of the replacement nozzle is done with a fillet structural pressure boundary weld.

6. A method as set forth in claim 2 wherein the step of repairing the existing nozzle includes a full replacement of the nozzle and a welding of the replacement nozzle to the weld pad.

7. A method as et forth in claim 6 wherein the welding of the replacement nozzle is done with a fillet structural pressure boundary weld.

8. A method as set forth in claim 6 wherein the welding of the replacement nozzle is done with a J-groove weld.

9. A method as set forth in claim 1 including the step of depositing a weld pad around the remaining non-defective nozzles of the pressure vessel.

10. A method as set forth in claim 8 including the step of repairing all nozzles found to be defective.
